(19) United States
(12) Patent Application Publication
(10) Pub. No.: US 2011/0088408 A1
(43) Pub. Date: Apr. 21, 2011

(54) FUEL INJECTOR MOUNTING SYSTEM

(75) Inventor: MICHAEL LAWRENCE CARLISLE, Derby (GB)

(73) Assignee: ROLLS-ROYCE PLC, London (GB)

(21) Appl. No.: 12/886,661

(22) Filed: Sep. 21, 2010

(30) Foreign Application Priority Data
Oct. 16, 2009 (GB) 0918089.4

(51) Int. Cl. F02C 7/20

(52) U.S. Cl. 60/796

(57) ABSTRACT

A system for mounting a fuel injector to an engine casing with an aperture includes a fuel injector having a flange for mounting to the casing at the aperture. The flange allows it to pass through the aperture. An intermediate ring mediates the mounting of the flange to the casing at the aperture. The intermediate ring is inside the casing at the aperture and defines an opening from which the fuel injector extends into the engine with the flange positioned inward of the ring. The flange is dismountably sealed to an inner side of the ring, and the ring is dismountably sealed to an inner side of the casing to mount the fuel injector to the casing. On dismounting the flange from the ring, the fuel injector can be displaced to allow the ring, to be moved away from the aperture. The fuel injector can then be withdrawn.

### CROSS REFERENCE TO RELATED APPLICATION

This application is entitled to the benefit of British Patent Application No. GB 0918089.4 filed on Oct. 16, 2009.

### FIELD OF THE INVENTION

The present invention relates to a system for mounting a fuel injector to a gas turbine engine.

### BACKGROUND OF THE INVENTION

Fuel is delivered to the combustion chamber(s) of a gas turbine engine by one or more fuel injectors.

Fuel injectors for aircraft gas turbine engines are often mounted externally of a casing of the combustion chamber at respective apertures through the casing. Each injector has a mounting flange which is sealingly connected to the external surface of the casing with a feed arm and tip of the injector passing through the aperture and the tip engaging into the head of the combustion chamber. Bolts secure the flange via threads in the casing.

However, a problem with this arrangement is that the securing bolts are working against the casing internal pressure. More particularly, the pressure difference across the casing may be in the range from about 35 to 4100 kPa, with the high pressure within the casing forcing the injector flange away from the casing. This can cause air leakage, and hence engine efficiency loss. On the other hand, an advantage of the arrangement is that the injector can be removed on-wing for maintenance or replacement.

An alternative arrangement has the injector flange sealingly connected to the internal surface of the casing. This overcomes the air leakage problem because the sealing arrangement is working with the internal pressure, i.e. the pressure difference across the casing forces the flange toward the casing. However, the internally mounted injector cannot be easily removed as the flange is too large to be withdrawn through the aperture. Thus the injector can only be removed from the inside, which requires a major engine strip, rendering on-wing maintenance or replacement effectively impossible.

Thus there is a need to provide a system for mounting a fuel injector to a gas turbine engine which facilitates on-wing removal of the injector while reducing air leakage.

### SUMMARY OF THE INVENTION

Accordingly, a first aspect of the present invention provides a system for mounting a fuel injector to a gas turbine engine, the system having:

an engine casing having an aperture formed therein,

a fuel injector having a flange for mounting the fuel injector to the casing at the aperture, the flange being configured to allow it pass through the aperture, and

an intermediate ring which mediates the mounting of the flange to the casing at the aperture, the intermediate ring being positioned inside the casing at the aperture and defining an opening from which the fuel injector extends into the engine with the flange positioned inward of the ring;

wherein:

the flange is dismountably sealed to an inner side of the ring, and the ring is dismountably sealed to an inner side of the casing to mount the fuel injector to the casing, and

on dismounting the flange from the ring, the fuel injector can be displaced to allow the ring, when dismounted from the casing, to be moved away from the aperture, such that the fuel injector can be withdrawn from the casing through the aperture.

With the exception of fluid (e.g. fuel) flow through the injector, the combination of the flange and ring can close off the aperture. Advantageously, the system combines an internal mounting arrangement for the injector, which can reduce air leakage, with an ability to withdraw the injector through the aperture, which facilitates on-wing removal of the injector.

The system may have any one or, to the extent that they are compatible, any combination of the following optional features.

Typically, the fuel injector is a fuel spray nozzle, such as an air spray nozzle.

The flange may interference fit to the intermediate ring when sealed to the inner side thereof. The intermediate ring may interference fit to the casing when sealed to the inner side thereof.

Typically, the engine casing has a plurality of apertures formed therein, each having a respective fuel injector and intermediate ring.

A further aspect of the invention provides a combination of the engine casing and the intermediate ring(s) of the first aspect.

A further aspect of the invention provides a combination of a fuel injector and an intermediate ring of the first aspect.

### BRIEF DESCRIPTION OF THE DRAWINGS

FIG. 1 shows a schematic diagram of a system for mounting a fuel injector to a gas turbine engine according to the present invention; and

FIG. 2 shows schematically a variant of the system of FIG. 1.

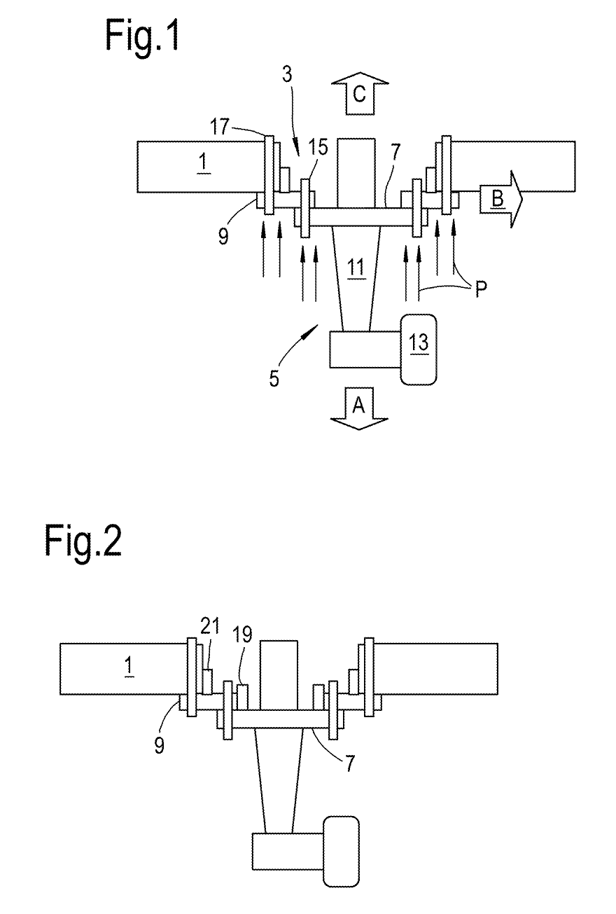

FIG. 1 shows a schematic diagram of a system for mounting a fuel injector to a gas turbine engine according to the present invention.

### DETAILED DESCRIPTION OF THE PREFERRED EMBODIMENTS

An engine casing 1 has a plurality of circumferentially spaced, essentially circular apertures 3. Each aperture is the mounting position for a fuel spray injector nozzle 5.

The nozzle 5 has a circular flange 7 whose diameter is less than that of the aperture 3, allowing the flange, and the rest of the nozzle to pass through the aperture.

An intermediate ring 9 is positioned between the flange 7 and the casing 1 to mediate mounting of the flange to the casing. The outer diameter of the ring is greater than the diameter of the aperture 3, while the inner diameter of the ring is less than that of the flange. To mount the nozzle 5 to the casing, the nozzle is positioned within the casing, with the feed arm 11 and tip 13 of the nozzle extending from the opening defined by the ring into the engine so that the tip engages with the head of a combustion chamber (not shown).

A first set of bolts 15 sealingly fasten the flange 7 to an inner side of the intermediate ring 9, and a second set of bolts 17 sealingly fasten the ring to an inner side of the casing 1. Both sets of bolts may employ HeliCoil™ inserts. The heads of both sets of bolts face outwardly, allowing the bolts to be fastened and unfastened from the outside of the casing.

The intermediate ring 9 can be positioned from the inside of the casing 1 on engine build, and can remain in the engine for life, or at least until the engine is stripped at overhaul, where they can be removed from the inside, for example, through the rear of the combustor module once apart from the turbine module.

The numbered arrows A to C indicate the successive operations to remove the nozzle 5 from the outside of the casing 1. Firstly, the bolts 15 holding the nozzle to the intermediate ring 9 are removed, and the nozzle is moved down (arrow A) into the casing. Secondly, the bolts 17 holding the ring to the casing are removed, and the ring moved sideways (arrow B) to clear the aperture 3. Thirdly, the nozzle is withdrawn (arrow C) through the aperture. The procedure allows the nozzle to be removed while the engine remains on-wing. To remount the nozzle to the casing, the sequence of operations is reversed.

Suitably configured tools can facilitate the operations A to C. For example, a nozzle tool can be screwed into an inlet thread of the nozzle 5, allowing the nozzle to be securely held from outside the casing when it is dropped into the engine at A. Likewise, a threaded blind hole in the intermediate ring 9 can allow a similar tool to hold the ring from outside the casing when it is translated at B. Alternatively, one of the bolts 17, in a loosened state, can retain the ring, allowing the ring to rotate about that bolt and away from the aperture 3.

The upwardly pointing arrows P indicate the forces exerted by the pressure differential across the casing 1, and show how the system promotes sealing of the aperture 3 by using an internally mounted flange 7. Grooves can be provided in the flange and the intermediate ring 9 to accept e.g. C-seals to improve sealing of the flange to the ring and the ring to the casing 1. Additionally or alternatively, as shown schematically in FIG. 2, the flange and the ring may have respective shoulder portions 19, 21 which interference fit to respectively the inner face of the opening defined by the ring and the inner face of the aperture. The interference fit could be promoted by freeze fitting, i.e. by cooling the ring and the flange before mounting or dismounting.

The system can significantly reduce leakage flow through the apertures 3, which can benefit engine efficiency, and reduce temperatures outside the casing 1.

1. A system for mounting a fuel injector to a gas turbine engine, the system comprising:
an engine casing having an aperture formed therein,
a fuel injector having a flange for mounting the fuel injector to the casing at the aperture, the flange being configured to allow it pass through the aperture, and
an intermediate ring which mediates the mounting of the flange to the casing at the aperture, the intermediate ring being positioned inside the casing at the aperture and defining an opening from which the fuel injector extends into the engine with the flange positioned inward of the ring;
wherein the flange is dismountably sealed to an inner side of the ring, and the ring is dismountably sealed to an inner side of the casing to mount the fuel injector to the casing, and
on dismounting the flange from the ring, the fuel injector can be displaced to allow the ring, when dismounted from the casing, to be moved away from the aperture, such that the fuel injector can be withdrawn from the casing through the aperture.

2. A system according to claim 1 wherein the engine casing has a plurality of apertures, each having a respective fuel injector and intermediate ring.

3. The combination of the engine casing and the intermediate ring(s) of claim 1.

4. The combination of the fuel injector and the intermediate ring of claim 1.
